(19) United States
(12) Patent Application Publication
(10) Pub. No.: US 2016/0300291 A1
(43) Pub. Date: Oct. 13, 2016

(54) SUPERMARKET SHOPPING MANAGEMENT SYSTEM

(71) Applicant: SIGAL CARMELI, REHOVOT (IL)

(72) Inventor: SIGAL CARMELI, REHOVOT (IL)

(21) Appl. No.: 14/684,460

(22) Filed: Apr. 13, 2015

(51) Int. Cl. G06Q 30/06; B65G 47/06; B65G 47/52

(52) U.S. Cl. CPC G06Q 30/0635; B65G 47/52; B65G 47/06

(57) ABSTRACT

A supermarket shopping management system, including: an ordering module for obtaining from a user an order including a list of goods, the ordering module including: a marking device, for marking goods to be added to the list of goods; a communication module, for communicating with a processing center via a communication channel; a processing center, being a computerized system for receiving the order from the user, and controlling conveying the goods from shelves on which the goods are stored to a cart of the user; a network of conveyors, including: linear conveyors; junction conveyors, for enabling moving of the goods in an orthogonal lane; and a pick-up module, controlled by the processing center, for pick-up the goods from the shelves, and placing them on a conveyor of the network of conveyors.

### TECHNICAL FIELD

The invention relates to the field of shopping management systems.

### BACKGROUND

Buying goods in supermarkets presently can be a very slow process. A consumer takes a cart, passes through the aisles, and fills the cart with the products he wants to buy. Then he goes to checkout, waits in line, and when his turn comes, the cashier scans the barcode of the products. This is a sustained process. Therefore, efforts have been made for years to perfect the process of purchasing goods in a supermarket by employing advanced technology. Nevertheless, the only improvement in decades has been scanning the barcode of the products instead of adding their prices individually.

### SUMMARY

In one aspect, the invention provides a solution to the above-mentioned and other problems of the prior art.

In one aspect, the invention is directed to a supermarket shopping management system, including:
an ordering module for obtaining from a user an order including a list of goods, the ordering module including:
   (a) a marking device, for marking goods to be added to the list of goods;
   (b) a communication module, for communicating with a processing center via a communication channel;
a processing center, being a computerized system for receiving the order from the user, and controlling conveying the goods from shelves on which the goods are stored to a cart of the user;
a network of conveyors, including:
   (a) linear conveyors;
   (b) junction conveyors, for enabling moving of the goods in an orthogonal lane; and
a pick-up module, controlled by the processing center, for pick-up the goods from the shelves, and placing them on a conveyor of the network of conveyors.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments, features, and aspects of the invention are described herein in conjunction with the following drawings:

FIG. 1 pictorially illustrates a supermarket shopping management system 10, according to one embodiment of the invention.

FIG. 2 further details the pick-up system, according to one embodiment of the invention.

FIG. 3 schematically illustrates traffic of a product 28 from one linear conveyor to the opposite linear conveyor through a junction conveyer, according to one embodiment of the invention.

FIGS. 4a, 4b and 4c schematically illustrate stages in traffic of a product 28 from one linear conveyor to an orthogonal conveyor thereof through a junction conveyer, according to one embodiment of the invention.

FIG. 5 is a block diagram that illustrates a supermarket shopping management system 10, according to one embodiment of the invention.

FIG. 6 is a side view illustrating the pick-up module of a supermarket shopping management system, according to one embodiment of the invention.

It should be understood that the drawings are not necessarily drawn to scale.

### DETAILED DESCRIPTION

The invention will be understood from the following detailed description of embodiments of the invention, which are meant to be descriptive and not limiting. For the sake of brevity, some well-known features, methods, systems, procedures, components, circuits, and so on, are not described in detail.

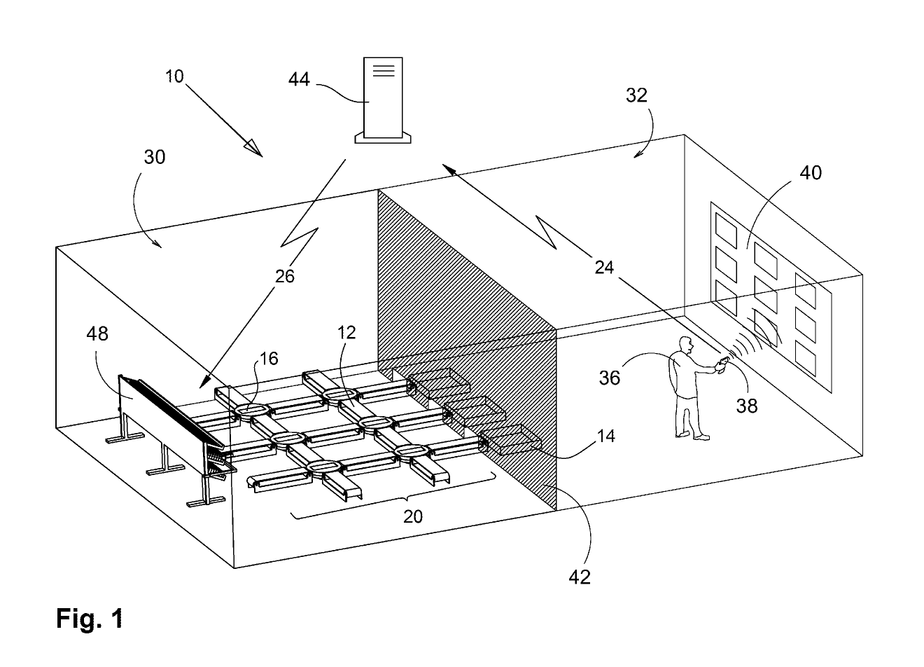

FIG. 1 pictorially illustrates a supermarket shopping management system 10, according to one embodiment of the invention.

Screens 40 present products and their barcodes. For example, one screen presents dairy products, while the other may present beverage products, and so on. The presentation may be changeable, i.e., one presentation fades, while the other is presented.

Each of the users 36 is provided with a marking device 38, which in this case may be a barcode scanner.

The use of marking devices 38 and screens 40 which present the products catalog is merely an example, and other alternatives can be used, such as shelves comprising the products (whether “real” products or empty packing thereof) where the user can scan their barcodes by the marking device 38, a software application on a smartphone with which the user may mark the products he wants to purchase, and so on.

The system 10 employs a communication channel 24 between the marking device 38 and processing center 44; and a communication channel 26 between the processing center 44 and the control unit(s) of the network 20 of linear conveyors 12 and junction conveyors 16. The communication channels may be wired as well as wireless, depending on the nature of the communicating devices.

An example of a linear conveyor is a “wide” belt (e.g. of 50 cm width) wrapped around two parallel rollers.

An example of a junction conveyor is a belt wrapped around two parallel rollers and installed on a rotatable pedestal, thereby allowing changing the angle of the belt with regard to the pedestal.

While marking the goods to be purchased, the user's order is processed by a processing center 44 (e.g., a server), and once his order has been processed, the user receives his cart 14, ready to be taken to his car. The user may even mark a request to pack his goods, so in comparison with current supermarket purchasing efforts, the purchase effort using the invention is diminished tremendously. And of course, the system may charge his credit card.

From the supermarket's point of view, during the time the user marks the goods, a list of goods is transferred to the processing center 44, which controls a conveying system that takes the ordered goods from shelves 48 in a warehouse hall 30 of the supermarket, puts the goods in a shopping cart 14, ready to be taken to the user's car. The system can also debit the user. In this way, the time period from when the user finishes his order until the goods are provided to him, is diminished tremendously.

When an order to a product is received at the processing center 44, the automatic system picks up the goods from shelves 48 and conveys them to shopping cart 14 via a network 20 of orthogonal linear conveyors 12 connected by junction conveyors 16, which are conveyors that can be rotated in orthogonal directions, as will be detailed hereinafter.

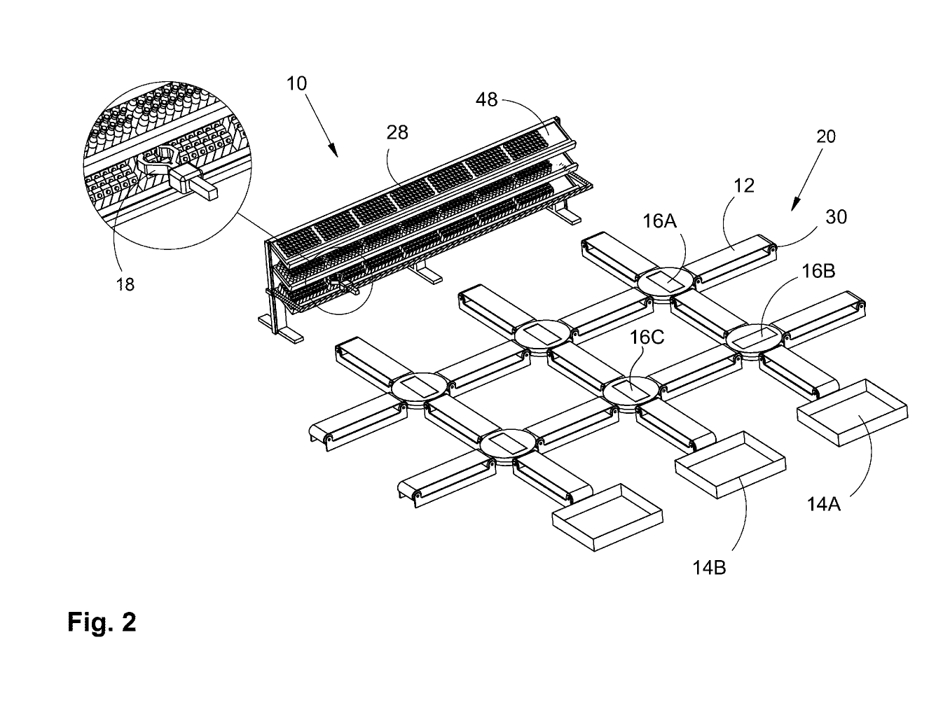

FIG. 2 further details the pick-up system, according to one embodiment of the invention.

The figure depicts products 28 placed on shelves 48. An arm 18 which is a part of a pick-up module, picks up a product 28, and places it on one of the linear conveyors 12. The mechanism that moves the arm (not illustrated) can be a robot controlling the arm, and so on. Such a mechanism can take into consideration the dimensions of each product and a predefined location to grasp the product. A more sophisticated robot can analyze the structure of the product while approaching thereto, and use this information to locate the arm.

As mentioned, the pick-up system uses a network 20 of orthogonal linear conveyors 12 connected by junction conveyors 16. Each of the junction conveyors comprises a linear conveyor installed on a rotatable base. For example, each of junction conveyors 16a and 16b of FIG. 2 is rotated in a different angle. Thus, when a product reaches to a junction conveyor, it can be directed to the front linear conveyor, left linear conveyor or right linear conveyor.

The pick-up system controls the speed of each of the linear conveyors, and even can stop it, e.g., until the junction conveyor rotates to enable the product to continue thereon, and so on. Thus, this system is computerized, and can employ an optimization module for reducing the time from selecting a product from shelve 48 until placing it in shopping cart 14.

The optimization module can be adapted to reduce the time required for filling the order of all the users, to priorities handling the shorter ordering lists in order to decrease the number of users being served simultaneously, and so on.

It should be emphasized that the pick-up system picks up products of a plurality of users simultaneously. This requires that when, for example, a junction conveyor 16 has to enable entrance of two products from different linear conveyors 12, one of the linear conveyors 12 must stop moving until the other linear conveyor ends its transfer. This is similar to a traffic junction, since when the traffic from one lane is allowed, the traffic from the other lanes is forbidden.

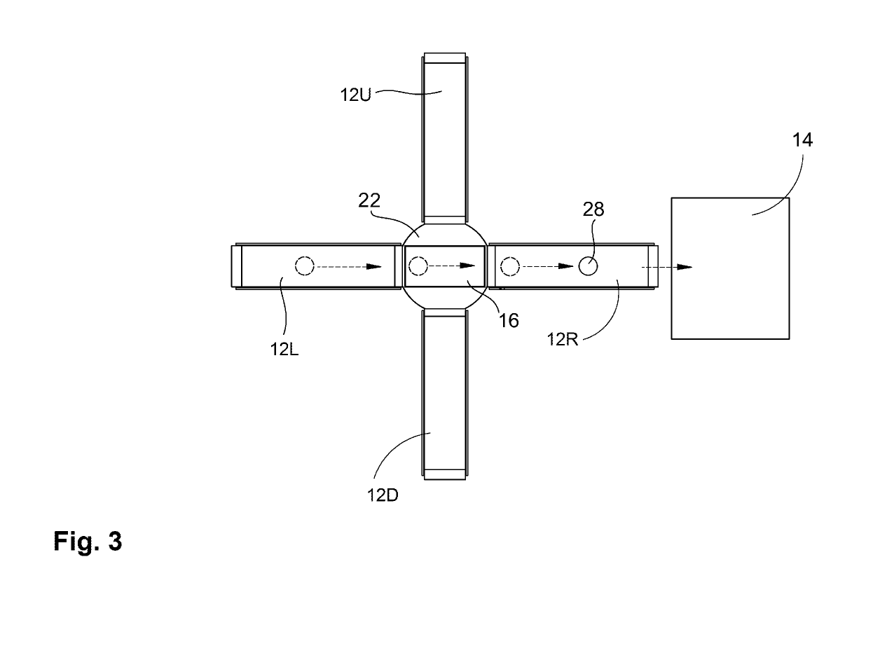

FIG. 3 schematically illustrates traffic of a product 28 from one linear conveyor to the opposite linear conveyor through a junction conveyer, according to one embodiment of the invention.

The product is marked herein by reference numeral 28. It moves on the left linear conveyor 12L (in the figure's orientation) to the right linear conveyor 12R, through the junction conveyor 16. The dashed line of a product 28 means a previous location.

The junction conveyor 16 is rotated such that it moves from left to right (in the figure's orientation). Thus, when product 28 reaches junction conveyor 16, it continues moving until reaching the right linear conveyor 12R, and therefrom to cart 14.

From the structural point of view, junction conveyor 16 is similar to linear conveyors 12. However, it is installed on a rotational pedestal 22 that can rotate in orthogonal directions.

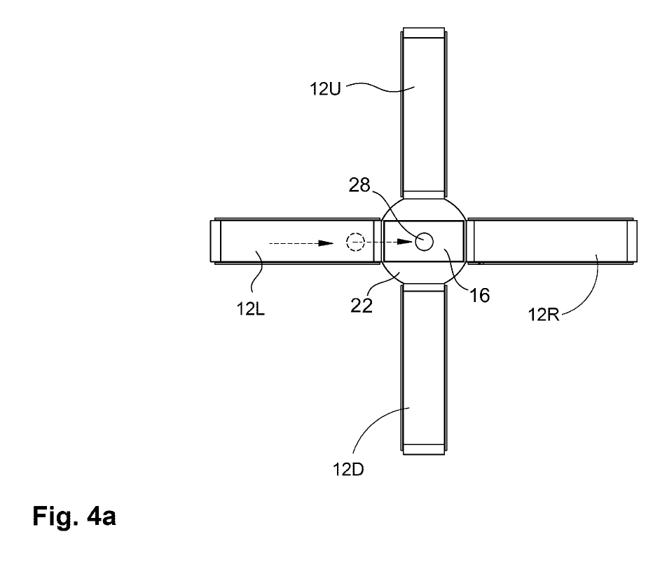

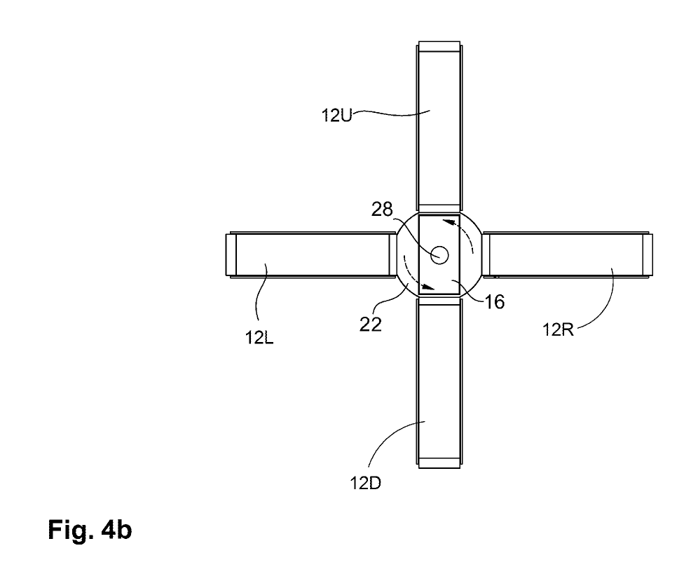

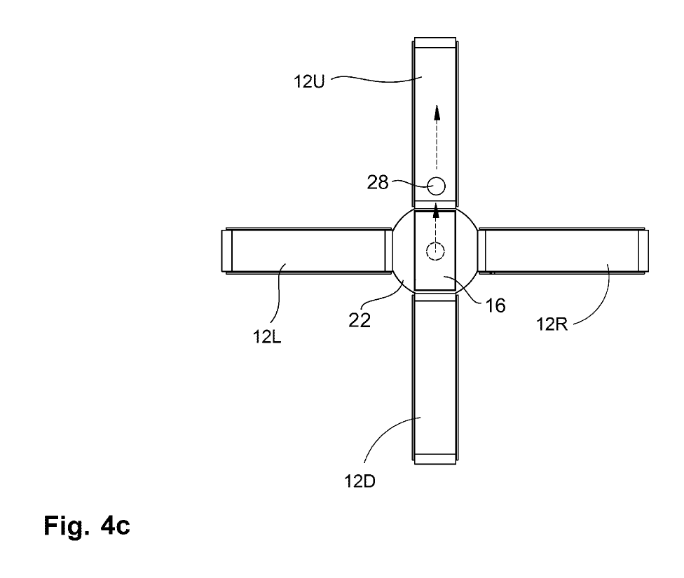

FIGS. 4a, 4b and 4c schematically illustrate stages in traffic of a product 28 from one linear conveyor to an orthogonal linear conveyor thereof through a junction conveyer, according to one embodiment of the invention.

More particularly, the product moves from linear conveyor 12L, to linear conveyor 12U, through junction conveyor 16.

In FIG. 4a, junction conveyor 16 is disposed horizontally (in the figure's orientation) such that its belt rotates from left to right.

Product 28 moves with linear conveyor 12L from left to right (in the figure's orientation) until it reaches junction conveyor 16. Then it continues to move from left to right on junction conveyor 16, eventually reaching to the center of junction conveyor 16. At this stage, junction conveyor 16 stops.

In FIG. 4b the rotational pedestal 22 on which junction conveyor 16 is installed rotates 90 degrees counterclockwise (in the figure's orientation).

In FIG. 4c junction conveyor 16 restarts, thereby causing the product to move to linear conveyor 12U.

Of course, the rotation of pedestal 22 can be carried out along with the movement of the product to the center of junction conveyor 16, thereby better utilizing the time.

One of the missions of the operation of processing center 44 is to optimize the time it takes the products to move from shelves 48 to the shopping carts of the users. The optimization is carried out continuously, since the processed information changes, for example as the users add products to their shopping list.

Removing an ordered product from the shopping cart can be carried out by a worker that waits at one of the pick-up points (where shopping carts 14 stand on FIG. 1).

In order to detect the current location of each product, a set of sensors can be used. For example, assuming the products are placed on a conveyor such that their barcode is on the top, a camera (not illustrated) disposed above each of the conveyors can photograph an image of the entire conveyor. The image can be analyzed in order to detect the product identification number and its current location.

Additionally or alternatively, the camera can detect the location of a product on a conveyor by comparing an image of an empty (of products) conveyor, even without the identification number.

Additionally or alternatively, on each of the conveyors are installed a first sensor (not illustrated) that detects when a product enters into the conveyor, and a second sensor (not illustrated as well) that detects when a product exits the conveyor.

The processing center 44 is a computerized system that processes the users' orders, and also controls the operation of the conveyors network 20, such as scheduling moving and stopping the belt of each conveyor, and in which direction (forward, backward), following each product, and so on. Of course, each operation may be carried out by a different module, and even by a different computerized system, but in general, these functionalities are coordinated by the processing center, which is marked herein by reference numeral 44.

As mentioned, one of the major roles of the processing center is optimizing the travel of the products from the shelves 48 to the shopping carts 14, in minimal time.

Of course, a user may define the time he is interested in taking to get his groceries, and this parameter also can be taken in consideration in the optimization process.

The system may be further adapted to send an SMS (Short Message Service) message to the user when the system has completed his order.

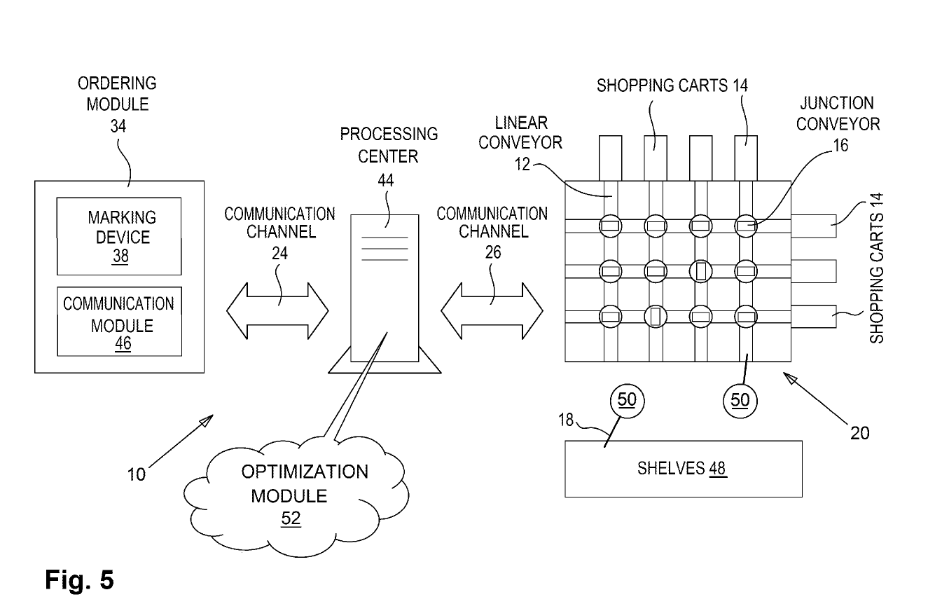

FIG. 5 is a block diagram that illustrates a supermarket shopping management system 10, according to one embodiment of the invention.

The system comprises the following major modules:
An ordering module (34) for obtaining from a user (36) an order including a list of goods, and controlling conveying the goods (28) from shelves (48) on which the goods are stored, to a cart (14) of the user, the ordering module comprising:
   a marking device (38), for marking goods (28) to be added to the list of goods;
   a communication module (46), for communicating with a processing center (44) via a communication channel (24).
A processing center (44), which is a computerized system for receiving the order from the user (36), and controlling conveying the goods (28) from shelves (48) on which the goods (28) are stored to a cart (14) of the user.
A network (20) of conveyors, comprising:
   linear conveyors (12);
   junction conveyors (16), for enabling moving of the goods (28) in an orthogonal lane.
A pick-up module (50), controlled by the processing center (44), for picking up the goods (28) from the shelves (48), and placing them on a conveyor (12, 16) of the network (20) of conveyors.

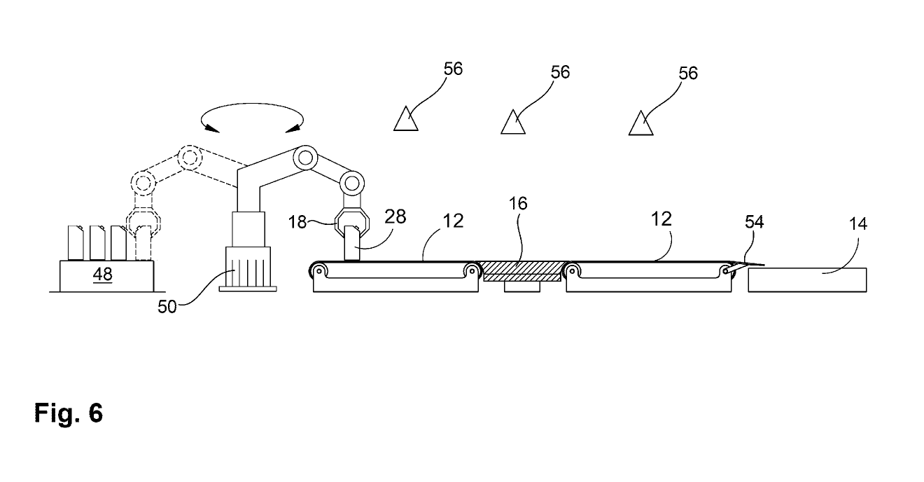

FIG. 6 is a side view illustrating the pick-up module of a supermarket shopping management system, according to one embodiment of the invention.

A robot (crane, and so on) 50, grasps by arm 18 a product 28 from shelf 48, and places it on linear conveyor 12. As illustrated, robot 50 has a base on which is installed arm 18, which ends with a clamp for grasping the product 28.

Reference numeral 54 denotes an inclined slide that leads to cart 14.

Thus, in one aspect, the invention is directed to a supermarket shopping management system, including:
an ordering module (34) for obtaining from a user (36) an order including a list of goods, the ordering module including:
   (c) a marking device (38), for marking goods (28) to be added to the list of goods;
   (d) a communication module (46), for communicating with a processing center (44) via a communication channel (24);
a processing center (44), being a computerized system for receiving the order from the user (36), and controlling conveying the goods (28) from shelves (48) on which the goods (28) are stored to a cart (14) of the user;
a network (20) of conveyors, including:
   (c) linear conveyors (12);
   (d) junction conveyors (16), for enabling moving of the goods (28) in an orthogonal lane; and
a pick-up module (50), controlled by the processing center (44), for pick-up the goods (28) from the shelves (48), and placing them on a conveyor (12,16) of the network (20) of conveyors.

The marking device (38) may include a code (barcode, QR code, and so on) scanner, for scanning the code of each physical product or virtual presented on a screen 40, wherein each screen may include a catalog of goods of the same kind (dairy, bakery, and so on).

According to one embodiment of the invention, the marking device (38) is a software application executed on a smartphone of the user, the application including a goods catalog, and means for selecting goods from the catalog.

A system according to claim 1, wherein each of the junction conveyors (16) is installed on a rotatable pedestal (22), thereby allowing rotating the junction conveyor at a desired angle.

According to one embodiment of the invention, each of the conveyors (12, 16) can be moved forward, backward and stopped by an order from the processing center (44).

It should be emphasized that the processing center is adapted to handle a plurality of users simultaneously.

According to one embodiment of the invention, the processing center includes an optimization module (52), for diminishing the time required to fulfill the order of all the users.

According to yet another embodiment of the invention, the processing center includes an optimization module (52), for prioritizing handling the shorter ordering lists in order to decrease the number of users being served simultaneously.

According to one embodiment of the invention, the processing center is adapted to perform an orthogonal movement of a product by moving the product to the center of the junction conveyor, stopping the junction conveyor when the product is at the center, rotating the pedestal thereof by 90 degrees, and then continuing to move the product in a linear movement.

According to another embodiment of the invention, the processing center is adapted to perform an orthogonal movement of a product by moving the junction conveyor (16) and rotating the pedestal (22) thereof simultaneously.

According to one embodiment of the invention, each of the conveyors (12, 16) includes a camera (56) thereabove, for detecting a location of the product (28) on the corresponding conveyor. Each of the cameras may further include a code reader.

According to one embodiment of the invention, each of the conveyors (12, 16) includes a laser sensor at the start thereof, and a laser sensor at the end thereof, for detecting when the product enters and leaves the conveyor.

According to one embodiment of the invention, the pick-up module (50) includes at least one robot, which employs an arm (18) for picking up a product from the shelves (48) and placing the product on a conveyor (12, 16).

In the figures and/or description herein, the following reference numerals (Reference Signs List) have been mentioned:
numeral 10 denotes a supermarket shopping management system, according to one embodiment of the invention;
each of numerals 12, 12L, 12R, 12U, 12D denotes a linear conveyor;
numeral 14 denotes a cart, such as a shopping cart;
each of numerals 16, 16a, 16b and 16c denotes a junction conveyor;
numeral 18 denotes an arm, such as a robotic arm;
numeral 20 denotes a network of conveyors;
numeral 22 denotes a rotatable pedestal;
numeral 24 denotes a communication channel between the marking device 38 and processing center 44;
numeral 26 denotes a communication channel between the processing center 44 and the control unit(s) of the network 20 of conveyors;
numeral 28 denotes a product (goods) sold in the supermarket;
numeral 30 denotes a warehouse hall in which the network 20 of conveyors is installed;
numeral 32 denotes a shopping hall;
numeral 34 denotes an ordering module, through which a user carries out an order of a list of goods;
numeral 36 denotes a user (customer, buyer);
numeral 38 denotes a marking device;
numeral 40 denotes a screen presenting goods and their associated code;
numeral 42 denotes a septum between the warehouse hall 30 and the shopping hall 32;
numeral 44 denotes a processing center, such as a computer executing a program;
numeral 46 denotes a communication module of the ordering module 34;
numeral 48 denotes goods shelves; and
numeral 50 denotes a pick-up module, such as a robot that employs arm 18;
numeral 52 denotes an optimization module;
numeral 54 denotes an inclined slide; and
numeral 56 denotes a camera as an example of a sensor for sensing the location of a product on a conveyor 12 or 16.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A supermarket shopping management system, comprising:
an ordering module for obtaining from a user an order including a list of goods, said ordering module comprising:
(a) a marking device, for marking goods to be added to said list of goods;
(b) a communication module, for communicating with a processing center via a communication channel;
a processing center, being a computerized system for receiving said order from said user, and controlling conveying said goods from shelves on which said goods are stored to a cart of said user;
a network of conveyors, comprising:
(a) linear conveyors;
(b) junction conveyors, for enabling moving of said goods in an orthogonal lane; and
a pick-up module, controlled by said processing center, for picking up said goods from said shelves, and placing them on a conveyor of said network of conveyors.

2. A system according to claim 1, wherein said marking device comprises a code scanner.

3. A system according to claim 1, wherein said marking device comprises a plurality of screens, each for displaying a catalog of goods.

4. A system according to claim 3, wherein each of said screens presents a category of goods.

5. A system according to claim 1, wherein said marking device is a software application executed on a smartphone of said user, said application comprising a goods catalog and means for selecting goods from said catalog.

6. A system according to claim 1, wherein each of said junction conveyors is installed on a rotatable pedestal, thereby allowing rotating said junction conveyor at a desired angle.

7. A system according to claim 1, wherein each of said conveyors can be moved forward, backward and can be stopped by an order from said processing center.

8. A system according to claim 1, wherein said processing center is adapted to handle a plurality of users simultaneously.

9. A system according to claim 8, wherein said processing center comprises an optimization module, for diminishing the time required for fulfilling the order of all the users.

10. A system according to claim 8, wherein said processing center comprises an optimization module, for prioritizing handling the shorter ordering lists in order to decrease the number of users being served simultaneously.

11. A system according to claim 1, wherein said processing center is adapted to perform an orthogonal movement of a product by moving the product to the center of the junction conveyor, stopping the junction conveyor when the product is at the center, rotating the pedestal thereof by 90 degrees, and then continuing moving the product in a linear movement.

12. A system according to claim 1, wherein said processing center is adapted to perform an orthogonal movement of a product by moving the junction conveyor and rotating the pedestal thereof simultaneously.

13. A system according to claim 1, wherein each of said conveyors comprises a camera thereabove, for indicating a location of said product on the corresponding conveyor.

14. A system according to claim 13, wherein each of said cameras further comprises a code reader.

15. A system according to claim 1, wherein each of said conveyors comprises a camera thereabove, for indicating a location of said product on the corresponding conveyor.

16. A system according to claim 1, wherein each of said conveyors comprises a laser sensor at the start thereof, and a laser sensor at the end thereof, for detecting when said product enters and leaves the conveyor.

17. A system according to claim 1, wherein said pick-up module comprises at least one robot, which employs said arm for picking up a product from the shelves and placing the product on a conveyor.
